(19) United States
(12) Patent Application Publication
(10) Pub. No.: US 2024/0320987 A1
(43) Pub. Date: Sep. 26, 2024

(54) CAMERA PERCEPTION TECHNIQUES FOR DRIVING OPERATION

(71) Applicant: TuSimple, Inc., SAN DIEGO, CA (US)

(72) Inventors: Haiping WU, Burnaby (CA); Long SHA, San Diego, CA (US); Hongyuan DU, San Diego, CA (US); Zilong GUO, San Diego, CA (US); Yihe TANG, San Diego, CA (US); Tingyu MAO, San Diego, CA (US); Pengfei CHEN, San Diego, CA (US); Panqu WANG, San Diego, CA (US); Rundong GE, San Diego, CA (US)

(21) Appl. No.: 18/598,384

(22) Filed: Mar. 7, 2024

Related U.S. Application Data
(60) Provisional application No. 63/492,113, filed on Mar. 24, 2023.

(51) Int. Cl. G06V 20/58; G06T 7/12; G06T 7/13; G06T 7/50; G06T 7/70; G06V 10/25

(52) U.S. Cl. CPC G06V 20/584; G06T 7/12; G06T 7/13; G06T 7/50; G06T 7/70; G06V 10/25; G06T 2207/30196; G06V 2201/07

(57) ABSTRACT

Techniques are described for performing an image processing technique on frames of a camera located on or in a vehicle. An example technique includes receiving, by a computer located in a vehicle, a first image frame from a camera located on or in the vehicle; obtaining a first combined set of information by combining a first set of information about an object detected from the first image frame and a second set of information about a set of objects detected from a second image frame, where the set of objects includes the object; obtaining, by using the first combined set of information, a second combined set of information about the object from the first image frame and from the second image frame; and causing the vehicle to perform a driving related operation in response to determining a characteristic of the object using the second combined set of information.

### CROSS-REFERENCE TO RELATED APPLICATIONS

This document claims priority to and the benefit of U.S. Provisional Patent Application No. 63/492,113, filed on Mar. 24, 2023. The aforementioned application of which is incorporated herein by reference in its entirety.

### TECHNICAL FIELD

This document relates to systems, apparatus, and methods to perform image processing techniques on one or more objects in images or image frames provided by a camera on or in a vehicle for driving operation.

### BACKGROUND

Autonomous vehicle navigation is a technology that can allow a vehicle to sense the position and movement of vehicles around an autonomous vehicle and, based on the sensing, control the autonomous vehicle to safely navigate towards a destination. An autonomous vehicle may operate in several modes. In some cases, an autonomous vehicle may allow a driver to operate the autonomous vehicle as a conventional vehicle by controlling the steering, throttle, clutch, gear shifter, and/or other devices. In other cases, a driver may engage the autonomous vehicle navigation technology to allow the vehicle to be driven by itself.

### SUMMARY

This patent document describes systems, apparatus, and methods to perform image processing techniques to detect and/or to determine characteristic(s) of one or more object located in images obtained by a camera on or in a vehicle.

An example method of driving operation includes receiving, by a computer located in a vehicle, a first image frame from a camera located on or in the vehicle; obtaining a first combined set of information by combining a first set of information about an object detected from the first image frame and a second set of information about a set of objects detected from a second image frame, where the set of objects includes the object; obtaining, by using the first combined set of information, a second combined set of information about the object from the first image frame and from the second image frame; and causing the vehicle to perform a driving related operation in response to determining a characteristic of the object using the second combined set of information about the object.

In some embodiments, the second combined set of information is obtained by combining a third set of information determined about the object in the first image frame with a fourth set of information about the object obtained from the second set of information related to the second image frame, and the third set of information about the object is determined using the first combined set of information. In some embodiments, the third set of information about the object is determined using the first combined set of information by: determining, based on information about the object from the first combined set of information, a location within the first image frame where a bounding box includes the object, and a description of a type of the object in the first image frame. In some embodiments, the type of object includes a traffic light, a vehicle, or a person. In some embodiments, the third set of information include a location of the object in the first image frame, and one or more characteristics of the object in the first image frame.

In some embodiments, the third set of information include a location within the first image frame where a bounding box includes the object. In some embodiments, the fourth set of information include one or more characteristics of the object from the second image frame. In some embodiments, the second image frame is received from the camera immediately prior to the receiving the first image frame. In some embodiments, the first set of information includes a first set of characteristics of the object from the first image frame. In some embodiments, the first set of information includes a proposed location within the first image frame where a bounding box includes the object. In some embodiments, the second set of information includes a second set of characteristics about the set of objects from the second image frame and from one or more image frames that precede the second image frame in time. In some embodiments, the second image frame is received from the camera prior to the receive the first image frame.

In some embodiments, the second combined set of information is obtained by combining a third set of information that is generated about the object in the first image frame with a fourth set of information about the object obtained from the second set of information related to the second image frame, and the third set of information about the object is generated using the first combined set of information. In some embodiments, the third set of information about the object is generated, using the first combined set of information, to include a location within the first image frame where a bounding box includes the object, and a description of a type of the object in the first image frame. In some embodiments, the method further comprises: updating the second set of information about the set of objects in the second image frame to include the third set of information about the object in the first image frame. In some embodiments, the method further comprises generating a mask or an outline that describes a shape of the object using the second combined set of information about the object. In some embodiments, the method further comprises determining locations where at least some portion of the object is in contact with a road using the second combined set of information about the object. In some embodiments, the second image frame is obtained by the camera prior to when the first image frame is obtained by the camera.

In yet another exemplary aspect, the above-described method is embodied in a non-transitory computer readable storage medium comprising code that when executed by a processor, causes the processor to perform the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a block diagram of an example vehicle ecosystem in which driving operations can be determined based on the image processing performed on images obtained from a camera on or in a vehicle.

FIG. 2 shows an example flowchart of image processing operations using multiple image frames obtained from a camera on or in a vehicle.

FIG. 3 shows an example flowchart for performing driving operation in a vehicle.

### DETAILED DESCRIPTION

When a camera provides a series of images to computer(s) located in a vehicle, the computer can perform image processing techniques to detect and/or to determine characteristic(s) of one or more object located in the images. The computer(s) can perform such image processing techniques using information at different granularities. For example, the computer(s) may include a bounding box to locate an object in an image, a classifier to determine what is the object, a mask to describe a shape of the object, a vector that includes a set of one or more values/words that describe one or more visual characteristics of the object to associate the object across different views or different time intervals, a key-point layout that indicates location(s) where the object touches the road to determine a pose of the object, etc. Current image processing technology can use either a single frame or exhaustively aggregate multiple frames to perform perception related image processing. In some embodiments, the techniques described in this patent document can effectively and efficiently leverage multiple frames for performing perception related image processing.

Section I provides an overview of the devices/systems located on or in a vehicle, such as an autonomous semi-trailer truck. The devices/systems can be used to perform the image processing techniques that are described in Section II of this patent document.

### I. Vehicle Driving Ecosystem

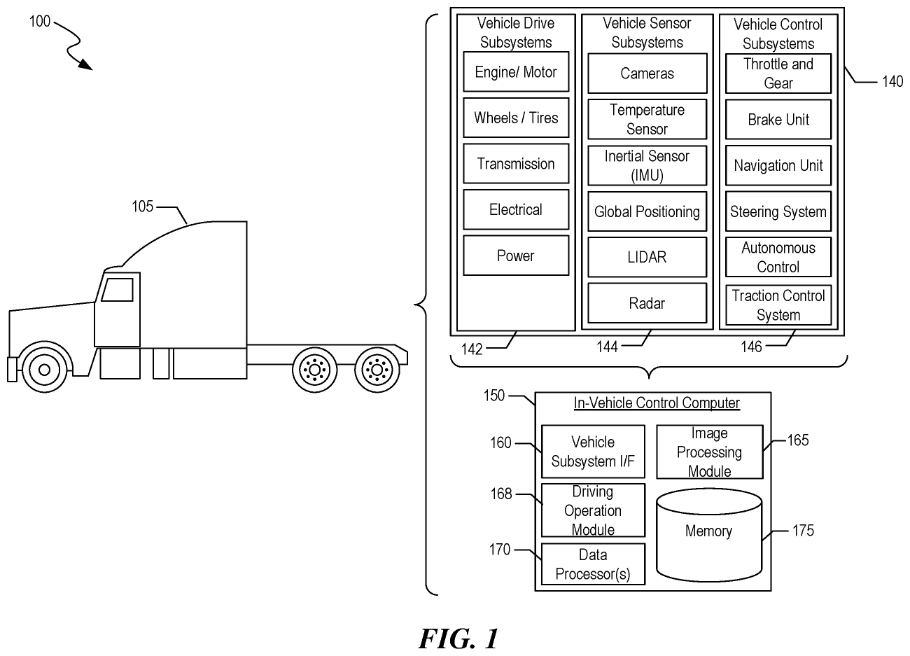

FIG. 1 shows a block diagram of an example vehicle ecosystem 100 in which driving operations can be determined based on the image processing performed on images obtained from a camera on or in a vehicle 105. As shown in FIG. 1, the vehicle 105 may be a semi-trailer truck. The vehicle ecosystem 100 includes several systems and components that can generate and/or deliver one or more sources of information/data and related services to the in-vehicle control computer 150 that may be located in a vehicle 105. The in-vehicle control computer 150 can be in data communication with a plurality of vehicle subsystems 140, all of which can be resident in the vehicle 105. A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The vehicle 105 may include various vehicle subsystems that support of the operation of vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems or one or more components or devices (e.g., LiDAR or Radar shown in FIG. 1) can be removed. The vehicle drive subsystem 142 may include components operable to provide powered motion for the vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment or condition of the vehicle 105. The sensors associated with the vehicle sensor subsystem 144 may be located on or in the vehicle 105. The vehicle sensor subsystem 144 may include one or more cameras or image capture devices, one or more temperature sensors, an inertial measurement unit (IMU), a Global Positioning System (GPS) transceiver, a laser range finder/LIDAR unit, a RADAR unit, and/or a wireless communication unit (e.g., a cellular communication transceiver). The vehicle sensor subsystem 144 may also include sensors configured to monitor internal systems of the vehicle 105 (e.g., an O₂ monitor, a fuel gauge, an engine oil temperature, etc.,).

The IMU may include any combination of sensors (e.g., accelerometers and gyroscopes) configured to sense position and orientation changes of the vehicle 105 based on inertial acceleration. The GPS transceiver may be any sensor configured to estimate a geographic location of the vehicle 105. For this purpose, the GPS transceiver may include a receiver/transmitter operable to provide information regarding the position of the vehicle 105 with respect to the Earth. The RADAR unit may represent a system that utilizes radio signals to sense objects within the local environment of the vehicle 105. In some embodiments, in addition to sensing the objects, the RADAR unit may additionally be configured to sense the speed and the heading of the objects proximate to the vehicle 105. The laser range finder or LIDAR unit may be any sensor configured to sense objects in the environment in which the vehicle 105 is located using lasers. The cameras may include one or more devices configured to capture a plurality of images of the environment of the vehicle 105. The cameras may be still image cameras or motion video cameras.

The vehicle control subsystem 146 may be configured to control operation of the vehicle 105 and its components. Accordingly, the vehicle control subsystem 146 may include various elements such as a throttle and gear, a brake unit, a navigation unit, a steering system and/or an autonomous control unit. The throttle may be configured to control, for instance, the operating speed of the engine and, in turn, control the speed of the vehicle 105. The gear may be configured to control the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS transceiver and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS transceiver, the RADAR, the LIDAR, the cameras, and/or other vehicle subsystems to determine the driving path or trajectory for the vehicle 105.

The traction control system (TCS) may represent a control system configured to prevent the vehicle 105 from swerving or losing control while on the road. For example, TCS may obtain signals from the IMU and the engine torque value to determine whether it should intervene and send instruction to one or more brakes on the vehicle 105 to mitigate the vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the vehicle 105 can be controlled by the in-vehicle control computer 150. The in-vehicle control computer 150 may include at least one data processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the vehicle 105 in a distributed fashion. In some embodiments, the memory 175 may contain processing instructions (e.g., program logic) executable by the data processor 170 to perform various methods and/or functions of the vehicle 105, including those described for the image processing module 165 and the driving operation module 168 as explained in this patent document. For instance, the data processor 170 executes the operations associated with image processing module 165 for detecting and/or determining characteristic(s) of object(s) located in image frames obtained from a camera on or in the vehicle 105. And, the data processor 170 executes the operations associated with driving operation module 168 for determining and/or performing driving related operations of the vehicle 105 based on the information provided by the image processing module 165.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 can be configured to include a data processor 170 and a memory 175. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146).

### II. Example Image Processing Techniques

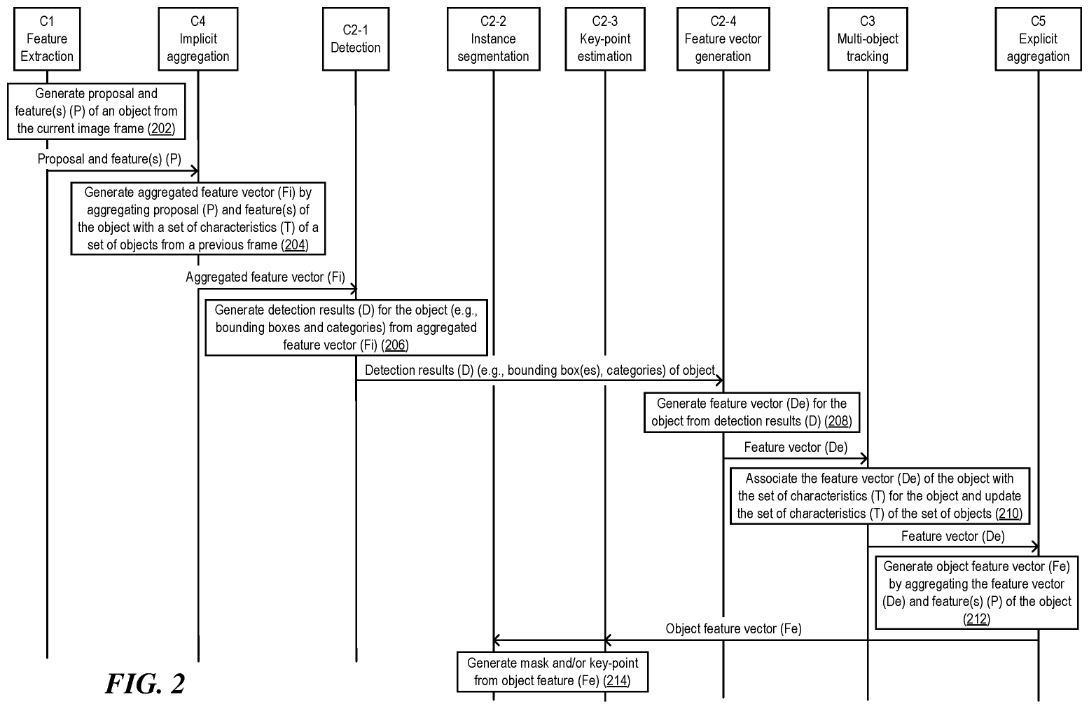

FIG. 2 shows an example flowchart of image processing operations using multiple image frames obtained from a camera on or in a vehicle. The top of FIG. 2 generally describes operations associated with C1-C5 can be performed by the image processing module (165 in FIG. 1) in some embodiments. In some other embodiments, the operation of each of C1-C5 can be performed by a corresponding image processing module in one or more computers located in the vehicle.

At C1, the image processing module performs a feature extraction operation that can use a deep neural network to extract features of an object from an image and a proposal for the object from the image. The features of the object may also be referred to as a first vector. The first vector of the object may include a set of one or more values/words that describe one or more visual characteristics of the object in the current image frame. A proposal may include a description of a proposed area of a bounding box that includes the object in the image.

At C2-1 to C2-4, the image processing module performs the operations as mentioned below:
At C2-1, the image processing module detects or determines a location of an object, outputs a bounding box around the object, and determines a category to which the object belongs (e.g., type of the object).
At C2-2, the image processing module performs instance segmentation where a mask for the object determined by C2-1 is determined. A bounding box can be rectangular box that surrounds the object. However, the bounding box may still include portions of the image other than the vehicle (e.g., a background). A mask determined at C2-2 by the image processing module may include an outline around just the object without the other portions of the image within the bounding box.
At C2-3, the image processing module performs key-point estimation to determine one or more locations where the object (or wheel(s) of the object) touches or contacts a road.
At C2-4, the image processing module performs a feature vector generation operation where a second vector for the object is determined and output. The second vector may include a set of one or more values/words that describe characteristics the object. The second vector may include tracking related information of the object and/or reidentification indication which indicates that an object that was not detected in a previous image frame is detected in a current image frame.

At C3, the image processing module performs multi-object tracking (e.g., by using neural network) to associate a detected object in a current image frame obtained from the camera to the same object from a previous image frame obtained from the camera. C3 may also update the vector associated with the object to update historical information of the object with information of the object from the current image frame.

At C4, the image processing module performs an implicit video or image frame feature aggregation operation where a first vector associated with the object is aggregated with vectors of multiple objects a previous image frame in an implicit manner. For example, if a previous image frame includes three objects and a current image frame includes the same three objects, then C4 can generate, for each object, an aggregated feature vector comprising a first vector of the object that describes a proposed area of a bounding box around the object and vectors that includes a set of characteristics of the three objects in the previous image frame.

At C5, the image processing module performs an explicit video or image frame feature aggregation operation where a vector associated with the object is aggregated with the vector of the same object from a previous image frame in an explicit manner. For example, if a previous image frame includes three objects and a current image frame includes the same three objects, then C5 can generate, for each object, a vector that includes characteristics of an object in the previous image frame, and one or more characteristics of the same object from the current image frame.

At operation 202, an image processing module performs feature extraction operation by generating features (also known as a first vector) of an object and one or more proposals (P) of the object from a current image frame obtained from a camera on or in a vehicle. The first vector may include a set of one or more values/words that describe one or more visual characteristics of the object. The first vector may also include the proposal that includes a description of a proposed area of a bounding box that includes the object in the current image frame. In some embodiments, a neural network may determine the first vector and the proposal(s) of the object using the current image frame.

At operation 204, the image processing module may generate an aggregated feature vector (Fi) by aggregating proposal(s) (P) and the first vector of the object from the current image frame with a set of characteristics (T) of a set of objects from a previous image frame. In some embodiments, the previous image frame is received in time prior to when the current image frame is received. In some embodiments, the previous image frame is received immediately prior to when the current image frame is received. The set of characteristics (T) of the set of objects describe visual characteristics of the set of objects. The aggregated feature vector (Fi) may include, for each object in the current image frame, the first vector of an object in the current image frame and the set of characteristics (T) of a set of objects (which may include the object) from a previous image frame. Thus, at operation 202, each object in the current image frame is associated has an aggregated feature vector (Fi). The technique to aggregate proposal(s) (P) of an object with the set of characteristics (T) of the set of objects including that object from the previous image frame is an advantageous technical feature. By performing an aggregation operation at operation 204, the image processing module can compensate for situations where a partial occlusion of the object in the current image frame can affect detection results obtained at operation 206. Thus, for instance, if an object is partially occluded in the current image frame, and if a proposal for an object is sent to C2-1 without aggregation, then at C2-1 the image processing module may generate an inaccurate detection result (D) for the object.

At operation 206, the image processing module may generate, for each object in the current image frame, a detection result (D) by using the aggregated feature vector (Fi) associated with that object. At operation 206, the image processing module can determine a location of the object in the current image frame to determine a corresponding bounding box around the object in the current image frame Thus, the detection result (D) of the object may include a bounding box around a location of the object and a type of the object (e.g., identifying that the object is a person, a truck, a traffic light, etc.). At operation 206, the image processing module can perform operations associated with C2-1 to detect and classify an object. For example, at operation 206, a confidence level of classifying an object as a car can be improved by referring to characteristics of other cars in the previous image frame.

At operation 208, the image processing module generates, for each object, a feature vector (De) (or second vector) for an object from the current image frame using the detection result (D) of the same object from a current image frame. The feature vector (De) for an object includes a set of one or more values/words associated with the current image frame that describe that object (e.g., location of the object in the current image frame, characteristic(s) of the object, a location of a bounding box (e.g., a single location of a bounding box) around the object in the current image frame, etc.). The characteristic(s) of the object in feature vector (De) may be the same as the feature(s) in operation 202.

At operation 210, the image processing module associates the feature vector (De) of an object in the current image frame with characteristic(s) of the same object from the set of characteristics (T) of a set of objects from a previous image frame. The set of characteristics (T) may include historical information of the set of objects up to the previous image frame, where the set of objects including the object that is the same as the one determined from the current image frame. Thus, at operation 210, the image processing module can also update the set of characteristics (T) of the set of objects from the previous image frame to (T′) to include the feature vector (De) of the object in the current image frame. T′ can be used by the image processing module as T in the next image frame. A technical benefit of updating the set of characteristics (T) of the set of objects from the previous image frame with the feature vector (De) of the object in the current image frame is that the image processing module can dynamically update the set of characteristics (T) so that the aggregation operations in operation 212 can be more efficient. The aggregation operation can be efficient at least because one feature vector in T may be used for each object to contain the characteristics of the object from multiple historical frames.

At operation 212, the image processing module generates an object feature vector (Fe) of an object by aggregating the associated feature vector from the set of characteristics (T) of the object from the previous image frame with the proposal feature (P) of the same object from the current image frame. The image processing module can generate the object feature vector (Fe) of the object using the techniques described for C5. At operation 212, by aggregating the associated feature vector from T of the object from the previous image frame with the proposal(s) (P) of the same object from the current image frame, the image processing module can perform the mask or key-point related operations as described in operation 214 because these operations include identifying specific features of the object.

At operation 214, the image processing module may use the object feature vector (Fc) for an object to generate a mask using the techniques described for C2-2 and to generate key-points or locations where the object touches or contacts the grounds using techniques described for C2-3. Since Fe can be a combination of the feature (P) of an object in the current image frame and the historical feature (T) of the same object in the previous image frame, Fe can have more information that just P or De alone. Thus, using the object feature vector Fe can be beneficial in some situations where, for example, the object in the current frame is blurred or occluded. In some embodiments, operations 202 to 214 can be repeated for each image frame obtained from the camera on or in the vehicle.

The image processing techniques described in this patent document can improve the accuracy of object-level camera perception performance and can provide tracking information. Using multiple image frames from a video feed of a camera can resolve some difficult image processing scenarios such as when an object is partially occluded or when a light condition changes. By using the set of characteristics (T) and two aggregation approaches described in operations 204 and 210, the image processing techniques described in this patent document can reduce a latency involved with performing image perception. For example, by using a previous image frame's set of characteristics (T) for the set of objects to perform image processing operations (instead of previous K frames (e.g., K=10)) can save computational resources and reduce memory consumption. Thus, instead of aggregating object-level features in the last K frames, the techniques described in this patent document can aggregate the object-level features with the set of characteristics (T) of the set of objects so that the time needed to perform image processing can be reduced and sufficient historical information can be preserved as the example image processing technique is performed.

In some embodiments, the driving operation module (shown as 168 in FIG. 1) can perform driving related operations in the vehicle using characteristics of an object obtained from the object feature (Fe) of the object, where the object is detected from an image frame, and where the characteristics may include visual characteristics of the object (e.g., type of object such as a traffic light or person or vehicle or emergency vehicle, color of the object), key-points of the object, a physical location of the object etc. For example, if the driving operation module determines that that a three-dimensional (3D) location of an object on the road, which is determined from the detected location of the object in a current image frame, is within a pre-determined distance of a physical location of the vehicle (105 in FIG.1), then the driving operation module can send instructions to a motor in the steering system to steer from a current lane to another lane or the driving operation module can send instructions to a brake system to apply brakes. In another example, if the driving operation module determines that that a characteristic of an object detected from a current image frame is that the object is an emergency vehicle, then the driving operation module can send instructions to a motor in the steering system and can send instructions to a brake system to cause the vehicle to steer and to stop to the side of the road.

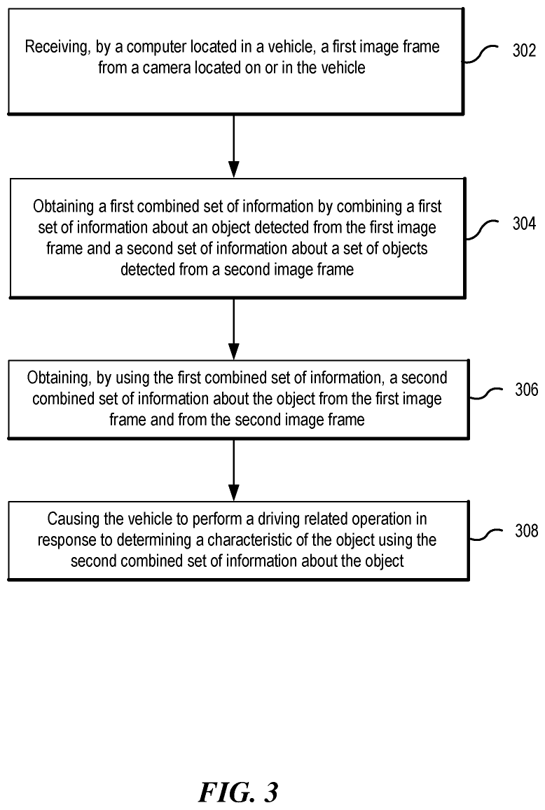

FIG. 3 shows an example flowchart for performing driving operation in a vehicle. Operation 302 includes receiving, by a computer located in a vehicle, a first image frame from a camera located on or in the vehicle. Operation 304 includes obtaining a first combined set of information by combining a first set of information about an object detected from the first image frame and a second set of information about a set of objects detected from a second image frame, where the set of objects includes the object. Operation 306 includes obtaining, by using the first combined set of information, a second combined set of information about the object from the first image frame and from the second image frame. Operation 308 includes causing the vehicle to perform a driving related operation in response to determining a characteristic of the object using the second combined set of information about the object.

In some embodiments, the first set of information may include proposal(s) and feature(s) of object in first image frame, the second set of information may include a set of characteristics (T) of objects, a first combined set of information may include aggregated feature vector (Fi), a third set of information may include feature vector (De) for the object, a fourth set of information may include characteristics of object from the set of characteristics (T), and a second combined set of information may include object feature vector (Fe).

In some embodiments, the second combined set of information is obtained by combining a third set of information determined about the object in the first image frame with a fourth set of information about the object obtained from the second set of information related to the second image frame, and the third set of information about the object is determined using the first combined set of information. In some embodiments, the third set of information about the object is determined using the first combined set of information by: determining, based on information about the object from the first combined set of information, a location within the first image frame where a bounding box includes the object, and a description of a type of the object in the first image frame. In some embodiments, the type of object includes a traffic light, a vehicle, or a person. In some embodiments, the third set of information include a location of the object in the first image frame, and one or more characteristics of the object in the first image frame.

In some embodiments, the third set of information include a location within the first image frame where a bounding box includes the object. In some embodiments, the fourth set of information include one or more characteristics of the object from the second image frame. In some embodiments, the second image frame is received from the camera immediately prior to the receiving the first image frame. In some embodiments, the first set of information includes a first set of characteristics of the object from the first image frame. In some embodiments, the first set of information includes a proposed location within the first image frame where a bounding box includes the object. In some embodiments, the second set of information includes a second set of characteristics about the set of objects from the second image frame and from one or more image frames that precede the second image frame in time. In some embodiments, the second image frame is received from the camera prior to the receive the first image frame.

In some embodiments, the second combined set of information is obtained by combining a third set of information that is generated about the object in the first image frame with a fourth set of information about the object obtained from the second set of information related to the second image frame, and the third set of information about the object is generated using the first combined set of information. In some embodiments, the third set of information about the object is generated, using the first combined set of information, to include a location within the first image frame where a bounding box includes the object, and a description of a type of the object in the first image frame. In some embodiments, the method further comprises: updating the second set of information about the set of objects in the second image frame to include the third set of information about the object in the first image frame. In some embodiments, the method further comprises generating a mask or an outline that describes a shape of the object using the second combined set of information about the object. In some embodiments, the method further comprises determining locations where at least some portion of the object is in contact with a road using the second combined set of information about the object. In some embodiments, the second image frame is obtained by the camera prior to when the first image frame is obtained by the camera.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of driving operation, comprising:
receiving, by a computer located in a vehicle, a first image frame from a camera located on or in the vehicle;
obtaining a first combined set of information by combining a first set of information about an object detected from the first image frame and a second set of information about a set of objects detected from a second image frame, wherein the set of objects includes the object;
obtaining, by using the first combined set of information, a second combined set of information about the object from the first image frame and from the second image frame; and
causing the vehicle to perform a driving related operation in response to determining a characteristic of the object using the second combined set of information about the object.

2. The method of claim 1,
wherein the second combined set of information is obtained by combining a third set of information determined about the object in the first image frame with a fourth set of information about the object obtained from the second set of information related to the second image frame, and
wherein the third set of information about the object is determined using the first combined set of information.

3. The method of claim 2, wherein the third set of information about the object is determined using the first combined set of information by:
determining, based on information about the object from the first combined set of information, a location within the first image frame where a bounding box includes the object, and a description of a type of the object in the first image frame.

4. The method of claim 3, wherein the type of object includes a traffic light, a vehicle, or a person.

5. The method of claim 2, wherein the third set of information include a location of the object in the first image frame, and one or more characteristics of the object in the first image frame.

6. The method of claim 2, wherein the third set of information include a location within the first image frame where a bounding box includes the object.

7. The method of claim 2, wherein the fourth set of information include one or more characteristics of the object from the second image frame.

8. The method of claim 1, wherein the second image frame is received from the camera immediately prior to the receiving the first image frame.

9. An apparatus for vehicle operation, comprising:
a processor configured to implement a method, the processor configured to:
receive a first image frame from a camera located on or in a vehicle;
obtain a first combined set of information by combining a first set of information about an object detected from the first image frame and a second set of information about a set of objects detected from a second image frame, wherein the set of objects includes the object;
obtain, by using the first combined set of information, a second combined set of information about the object from the first image frame and from the second image frame; and
cause the vehicle to perform a driving related operation in response to determining a characteristic of the object using the second combined set of information about the object.

10. The apparatus of claim 9, wherein the first set of information includes a first set of characteristics of the object from the first image frame.

11. The apparatus of claim 9, wherein the first set of information includes a proposed location within the first image frame where a bounding box includes the object.

12. The apparatus of claim 9, wherein the second set of information includes a second set of characteristics about the set of objects from the second image frame and from one or more image frames that precede the second image frame in time.

13. The apparatus of claim 9, wherein the second image frame is received from the camera prior to the receive the first image frame.

14. A non-transitory computer readable program storage medium having code stored thereon, the code, when executed by a processor, causing the processor to implement a method, comprising:
receiving, by a computer located in a vehicle, a first image frame from a camera located on or in the vehicle;
obtaining a first combined set of information by combining a first set of information about an object detected from the first image frame and a second set of information about a set of objects detected from a second image frame, wherein the set of objects includes the object;
obtaining, by using the first combined set of information, a second combined set of information about the object from the first image frame and from the second image frame; and
causing the vehicle to perform a driving related operation in response to determining a characteristic of the object using the second combined set of information about the object.

15. The non-transitory computer readable program storage medium of claim 14,
wherein the second combined set of information is obtained by combining a third set of information that is generated about the object in the first image frame with a fourth set of information about the object obtained from the second set of information related to the second image frame, and
wherein the third set of information about the object is generated using the first combined set of information.

16. The non-transitory computer readable program storage medium of claim 15, wherein the third set of information about the object is generated, using the first combined set of information, to include a location within the first image frame where a bounding box includes the object, and a description of a type of the object in the first image frame.

17. The non-transitory computer readable program storage medium of claim 15, wherein the method further comprises:
updating the second set of information about the set of objects in the second image frame to include the third set of information about the object in the first image frame.

18. The non-transitory computer readable program storage medium of claim 14, wherein the method further comprises:
generating a mask or an outline that describes a shape of the object using the second combined set of information about the object.

19. The non-transitory computer readable program storage medium of claim 14, wherein the method further comprises:
determining locations where at least some portion of the object is in contact with a road using the second combined set of information about the object.

20. The non-transitory computer readable program storage medium of claim 14, wherein the second image frame is obtained by the camera prior to when the first image frame is obtained by the camera.
